(19) United States
(12) Patent Application Publication
(10) Pub. No.: US 2020/0249095 A1
(43) Pub. Date: Aug. 6, 2020

(54) System for Measuring Optical Phase of a Specimen Using Defocused Images Thereof

(71) Applicant: WAVEFRONT ANALYSIS INC, Ardsley, NY (US)

(72) Inventor: Thomas D. Milster, Tucson, AZ (US)

(21) Appl. No.: 16/778,025

(22) Filed: Jan. 31, 2020

Related U.S. Application Data
(60) Provisional application No. 62/800,059, filed on Feb. 1, 2019.

(51) Int. Cl. G01J 9/02; G02B 21/36; G02B 3/14

(52) U.S. Cl. CPC G01J 9/02; G02B 21/361; G01J 2009/0269; G01J 2009/0253; G02B 3/14

(57) ABSTRACT

An optical system for determining the optical phase of an object of interest located at an input plane of the system. The system may include a variable-focus optical imaging system for creating an image of the object of interest at an output plane of the imaging system. An optical detector may be provided at the output plane for receiving the image of the object. A controller may be operably connected to the vari-focal element to adjust the optical power of the variable-focus optical imaging system. The controller may also be configured to create a plurality of defocused images of the object at the output plane and be connected to the detector to capture each of the plurality of defocused images.

### RELATED APPLICATIONS

The present application claims priority to U.S. Provisional Patent Application No. 62/800,059, filed on Feb. 1, 2019, the entire contents of which is incorporated herein by reference.

### FIELD OF THE INVENTION

The present invention relates generally to optical systems for measuring phase information of an object of interest, and more particularly but not exclusively to a microscope system which creates one or more defocused images of an object from which images phase information of the object is determined.

### BACKGROUND OF THE INVENTION

Biological cells are nearly transparent when observed through a simple microscope. However, there is a great wealth of information in subtle differences of the intracellular structure. For many years, scientists have been developing ways to observe and quantify these differences with optical microscopes. One parameter of particular interest is the density of the intracellular structure. When a laser beam passes through cellular material of higher density than its surroundings, it slows down. Upon exiting the cell, this part of the laser beam is delayed “behind” the beam passing through the less-dense surrounding material. The delay is called the phase of the laser beam, and the transmitted phase is indicative of density variations inside the cell. Accordingly, it would be a useful advance in the state of the art to provide a device that can measure phase in objects, including cellular material.

### SUMMARY OF THE INVENTION

In one of its aspects the present invention may provide an optical system for determining the optical phase of an object of interest located at an input plane of the system. The system may include a variable-focus optical imaging system, such as a liquid lens, for example, for creating an image of the object of interest at an output plane of the imaging system. The system may include a vari-focal element disposed therein for adjusting the amount of defocus present in the image at the output plane. An optical detector may be provided at the output plane for receiving the image of the object. A controller may be operably connected to the vari-focal element to adjust the optical power of the vari-focal element. The controller may also be configured to create a plurality of defocused images of the object at the output plane, and be connected to the detector to operate the detector to capture each of the plurality of defocused images. The variable-focus optical imaging system may include an objective lens disposed at a location adjacent the input plane. The objective lens may have an exit pupil associated therewith with the vari-focal lens located at an optical conjugate of the exit pupil.

The optical system may also include an optical illumination system configured to illuminate the input plane at an orientation to allow the optical illumination to propagate through the variable-focus optical imaging system. The optical illumination system may include a circuit to provide frequency modulation sufficiently large to widen the temporal bandwidth of the spectrum of the optical illumination. A laser diode may be the source of optical illumination.

### BRIEF DESCRIPTION OF THE DRAWINGS

The foregoing summary and the following detailed description of exemplary embodiments of the present invention may be further understood when read in conjunction with the appended drawings, in which:

FIG. 1 illustrates a block diagram of the method of U.S. Pat. No. 6,906,839;

FIG. 2 schematically illustrates an exemplary configuration of a microscope in accordance with the present invention; and

FIG. 3 schematically illustrates an exemplary configuration of an illumination system of the present invention suitable for use with the microscope of FIG. 2.

### DETAILED DESCRIPTION OF THE INVENTION

Referring now to the figures, wherein like elements are numbered alike throughout, in one of its aspects the present invention may provide an optical system, such as a microscope, that uses a series of defocused images of an object of interest to compute the transmitted phase of the object as a function of position. The algorithm used for the calculation is based on U.S. Pat. No. 6,906,839 (“'839 patent”), the entire contents of which are incorporated herein by reference. A particular advantage of this algorithm is its simplicity compared to other techniques that quantify transmitted phase.

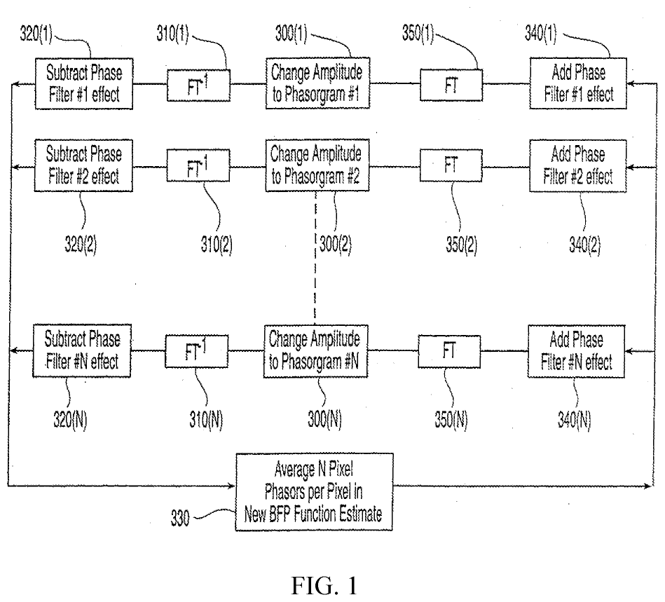

FIG. 1 illustrates a flowchart that describes the phase reconstruction algorithm used in the instant application. As used herein, the term “phasorgrams” in FIG. 1 refers to defocused images of the object of interest. The “filters” referred to in the flowchart of FIG. 1 create a known amount of defocus used to produce each phasorgram. In the microscope of the present invention, the defocus is found through a calibration step. The flowchart of FIG. 1 shows that N phasorgrams (defocused images) are collected and processed in one data acquisition series, with each series located in a specific row of the flowchart. Arrows indicate the direction of the calculation flow. A single cycle of the path around the loop is called an iteration. FT stands for Fourier transform, which is a mathematical operation in the calculation. FT⁻¹ stands for inverse Fourier transform, which is a similar mathematical operation.

FT and FT⁻¹ operations are very important, because they relate the camera image to the light distribution in a special plane of the microscope called the pupil. Humans have a pupil in each eye in a similar way to the pupil of a microscope. The eye's pupil is some distance away from the retina, where the image of the scene being observed is focused. Similarly, the pupil of a microscope is some distance from the camera. The phase in the pupil is directly related to the transmitted phase of the object of interest in the object plane by the FT mathematical operation. For the calculation described in the '839 patent, both the phase in the pupil and the phase of the object are utilized.

In one iteration of the calculation, the phasorgram amplitudes are loaded into the boxes labeled 300(1) . . . 300(N), FIG. 1. Phase effect values are loaded into the boxes labeled 340(1) . . . 340(N) and 320(1) . . . 320(N). The current estimate of the pupil phase is loaded into box 330. (At the start of the calculation on the first iteration, the current estimate is a uniform value.) The current estimate of the pupil phase 330 is processed by adding the values in step 340(1) . . . 340(N) on the right-hand side of the flowchart, one for each phase adjusted image. Then a FT is applied in boxes 350(1) . . . 350(N). If the current estimate of the pupil phase is perfect, the result of this operation would be images that are exactly the same as the measured phase-adjusted images. However, this is not the case for early iterations. In the 300(1) . . . 300(N) boxes, the calculated images from 350(1) . . . 350(N) are stripped of their amplitudes and replaced with measured amplitudes, but phase values from the calculation are kept. Then, the FT⁻¹ operation is applied in 310(1) . . . 310(N), and the results are stripped of the phase values in 320(1) . . . 320(N). These results are then averaged to generate the next estimate of the pupil phase.

After several iterations, the calculation stabilizes, and the pupil phase is retrieved from the calculation. A simple FT operation is used to calculate the transmitted phase of the non-defocused object. The present invention provides a system for adding a known amount of defocus to an image of an object under test, and the defocus serves as the phase change of steps 320(1) . . . 320(N) and 340(1) . . . 340(N) in FIG. 1.

Turning to an exemplary apparatus in accordance with the present invention, such apparatus may be described as having two components: a microscope 100 and a custom illumination source 200 to illuminate an object to be viewed by the microscope 100. A custom software package for control of the data acquisition, calibration of the microscope, and reconstruction of the phase of the object may also be provided.

### The Main Microscope Body

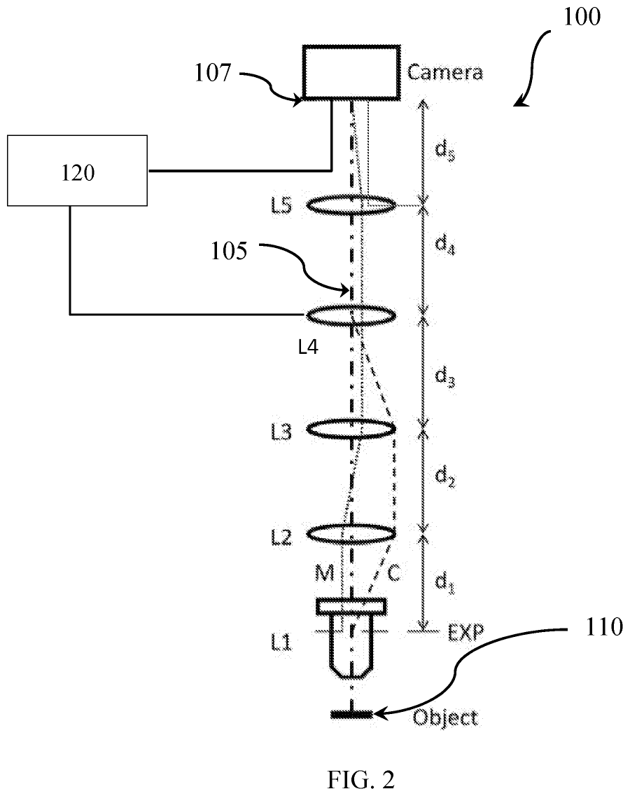

A prototype of an exemplary microscope 100 in accordance with the present invention was designed and built as shown schematically in FIG. 2. There were six lenses (L1-L6), an object, and a camera, which were implemented using commercially available components. (Mechanical supports, mounting brackets, light shields, and cables are not shown.) An object in an object plane 110, such as cells, may be illuminated from below.

The lens L1 in the microscope 100 was a 0.5 numerical aperture (NA) microscope objective lens (Part No. UPlanFLN, Olympus Corporation of the Americas, Center Valley, Pa., USA) that was corrected for infinite conjugates. That is, a point source in the object plane 110 produced collimated light after transmission through L1. An important aspect of lens L1 was the exit pupil (“EXP”) location, where a plane wave from the object plane 100 came to a point focus. The exit pupil plane EXP was the reference plane for determining distances d1-d5, FIG. 2.

The marginal (M) and chief (C) rays are illustrated in FIG. 2 as dotted and dashed lines, respectively. The symmetry center line is illustrated with a dash-dot line, which is also the optical axis 105 for this system. The marginal ray starts at the center of the object and is collimated (parallel to the optical axis 105) after transmitting through the exit pupil EXP. Intersection of the marginal ray with the optical axis 105 determines locations of image conjugates. In the microscope 100, there were two image conjugates; one of which was between lens L2 and lens L3, and one of which was at the camera plane 107. (Note that the section of the marginal ray from the object to the exit pupil is not shown, because detailed design of the microscope objective L1 was not known.) The chief ray intersected the optical axis 105 at EXP, and each successive intersection of the chief ray with the optical axis 105 determined locations of EXP conjugates. There was one EXP conjugate in the microscope 100, which was located at lens L4.

Lenses L2 and L3 formed a pupil relay to image EXP into lens L4. Off-the-shelf achromatic doublets were used having a focal length f=75 mm (Part No. AC254-075, Thorlabs, Inc, New Jersey, USA). During alignment, a plane wave parallel to the optical axis 105 illuminated lens L1, which formed a point image at EXP. Lens L2 distance d1 was adjusted by observing the output of a shear-plate interferometer such that light transmitted through lens L2 was collimated. Distance d2 was adjusted by removing lens L1 from the system and observing the transmitted light through lens L3 such that the shear plate interferometer indicated that the light was collimated. Lens L1 was then replaced. At this point in the alignment, lenses L2 and L3 effectively imaged the exit pupil EXP to a conjugate plane at the lens L4.

The lens L4 was a tunable focus (vari-focal) lens that operated on the principle of fluid-filled electroactive polymers aka a “liquid lenses.” The particular lens L4 (Optotune Focus-Tunable Lens, Part No. 88-939, Edmund Optics, Inc., Barrington, N.J., USA) used in the microscope 100 allowed for −1.5 to +3.5 diopters of optical power change. The liquid lens L4 was but one exemplary type of lens for use in the system 100 of the present invention to change the phase distribution of the transmitted or reflected beam without physical motion of the element in the transverse plane. Another exemplary element for use as the lens L4 is a liquid crystal on silicon (LCOS) spatial light modulator.

A cable (not shown) was connected to the computer 120 for controlling the lens L4 and to provide automated focus change. Before alignment in the system, the “zero” power (P=0) condition for the lens L4 was determined by illuminating it with an on-axis plane wave and observing the transmitted beam with a shear plate until the transmitted beam was collimated. During alignment, the lens L4 was positioned such that the focal point from a plane wave illuminating the lens L1 was coincident with the optical power surface of the lens L4.

The lens L5 was an off-the-shelf f=150 mm achromat (Part No. AC254-150, Thorlabs, Inc, New Jersey, USA) that is commonly referred to as a “tube lens” and focused an image of the object onto the camera. For alignment of lens the L5, P=0 and the lens L1 was removed. An on-axis plane wave illuminated the system with no object present, and d4 was adjusted until a shear plate indicated that collimated light was transmitted through the lens L5. After alignment, the lens L1 was replaced.

The distance d5 was adjusted by illuminating the system with an on-axis plane wave without the object present and moving the camera until the smallest spot was observed in the camera image. The camera (Part No. acA2040-55 um-Basler ace USB3 Micro, Basler Inc., Exton, Pa., USA) was connected to the controlling computer 120 with a cable for adjusting camera settings and automated downloading of images in synchronization with the focus change of the lens L4.

### Object Illumination

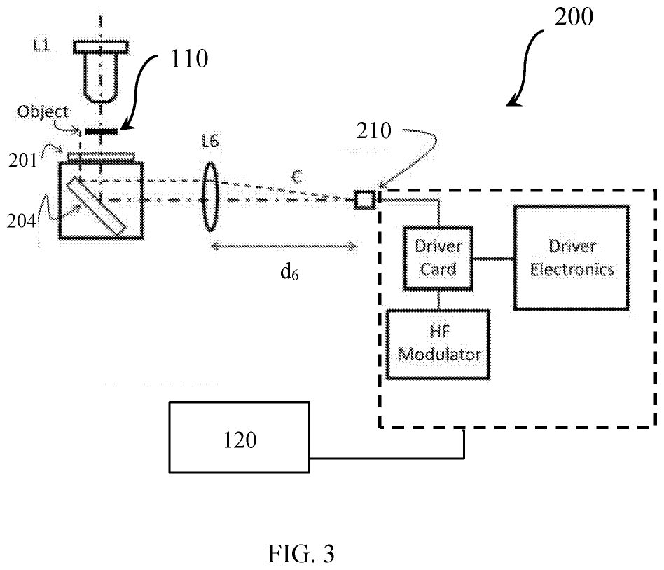

A representative diagram of an exemplary microscope illumination system 200 in accordance with the present invention is shown in FIG. 3. The exemplary light source used was a laser diode 210 (Part No. HL6323MG, Thorlabs, Inc, New Jersey, USA) that operated at a wavelength of 639 nm and provided up to 30 mW of output power. The laser diode 210 was essentially a point source. In order to provide collimated plane-wave illumination on the object, the distance d6 was adjusted so that a shear plate indicated collimated transmission through the lens L6, which was an off-the-shelf f=150 mm achromat (Part No. AC254-150, Thorlabs, Inc, New Jersey, USA). A set of turn mirrors 204 was used to adjust the collimated light transmitted through the lens L6 so that it aligned with the optical axis 105 of the main microscope body. A transparent window 201 was used to protect the turn mirrors 204 from accidental contamination while handling different objects.

A high-frequency (HF) driver card (Part No. T1G (Bias-T PCB), Thorlabs, Inc, New Jersey, USA) was attached close to the electrical leads of the laser diode 210 in order to allow HF modulation of the laser diode driver current. The HF signal was supplied by a small, adjustable HF modulator (TPI Synthesizer Version 5.8, Trinity Power, Inc., Austin, Tex., USA), which was set to a modulation frequency of 300 MHz. The primary laser diode drive current was supplied by commercially available driver electronics (Part No. EK1101, Thorlabs, Inc, New Jersey, USA), which was battery powered to avoid AC line noise in the driver circuit. HF modulation was used to slightly widen the temporal bandwidth of the laser diode optical spectrum, with the modulator frequency well beyond the frequency used for data collection. (Without HF modulation, a dominant single longitudinal mode would be emitted that chaotically switched from one wavelength to another, causing unwanted background fringes from surfaces near the object plane 110. The background fringe pattern would change when the mode switched wavelength, which would complicate the reconstruction algorithm and resulted in an inaccurate phase calculation.) A custom Matlab user interface was written to operate the camera for focusing on the object, to collect data in the form of phasorgrams, and to process the phasorgrams for calculation of the object phase.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An optical system for determining the optical phase of an object of interest located at an input plane of the system, comprising:
a variable-focus optical imaging system for creating an image of the object of interest, the image located at an output plane of the imaging system, and the variable-focus optical imaging system having a vari-focal element disposed therein for adjusting the amount of defocus present in the image at the output plane;
an optical detector disposed at the output plane for receiving the image of the object; and
a controller operably connected to the vari-focal element to adjust the optical power of the vari-focal element, the controller configured to create a plurality of defocused images of the object at the output plane, the controller operably connected to the detector to operate the detector to capture each of the plurality of defocused images.

2. The optical system of claim 1, wherein the vari-focal element comprises a liquid lens.

3. The optical system of claim 1, wherein the variable-focus optical imaging system includes an objective lens disposed at a location adjacent the input plane, the objective lens having an exit pupil associated therewith and wherein the vari-focal lens is located at an optical conjugate of the exit pupil.

4. The optical system of claim 3, comprising one or more lenses disposed between the objective lens and the vari-focal lens to image the exit pupil to the location of the vari-focal lens.

5. The optical system of claim 1, comprising an optical illumination system configured to illuminate the input plane at an orientation to allow the optical illumination to propagate through the variable-focus optical imaging system, the optical illumination system comprising a circuit to provide frequency modulation sufficiently large to widen the temporal bandwidth of the spectrum of the optical illumination.

6. The optical system of claim 5, wherein the optical illumination system includes a laser diode as the source of optical illumination.

7. The optical system of claim 5, wherein the frequency of modulation is greater than a frequency used for data collection.
